(19) United States
(12) Patent Application Publication
(10) Pub. No.: US 2013/0290347 A1
(43) Pub. Date: Oct. 31, 2013

(54) SYSTEMS AND METHODS FOR PROVIDING DATA-DRIVEN DOCUMENT SUGGESTIONS

(71) Applicant: Joseph SAIB, Santa Clara, CA (US)

(72) Inventor: Joseph SAIB, Santa Clara, CA (US)

(73) Assignee: APPSENSE LIMITED, Warrington (GB)

(21) Appl. No.: 13/457,136

(22) Filed: Apr. 26, 2012

(51) Int. Cl. G06F 17/30

(52) U.S. Cl. 707/748; 707/E17.009

(57) ABSTRACT

Systems and methods are disclosed for providing at least one document suggestion from a computer system using at least one information source, the method comprising storing in the information source a plurality of associations, each of which includes a numeric coefficient that corresponds to at least one action of a user and at least one document; receiving a triggering action related to the at least one action of the user; comparing the numeric coefficients stored in the information source with a suggestion threshold based on the triggering action; and for each numeric coefficient that exceeds the suggestion threshold, identifying the corresponding at least one document as a suggested document.

### CROSS-REFERENCE TO RELATED APPLICATIONS

This application is related to the following applications, filed herewith and hereby incorporated by reference: “Systems and Methods for Mining Organizational Data to Form Social Networks” (U.S. Application No. TBD), and “Systems and Methods for Automatically Associating Tags With Files in a Computer System” (U.S. Application No. TBD).

### BACKGROUND

1. Technical Field

Disclosed systems and methods relate to automatically providing data-driven document suggestions in a computer system.

2. Description of the Related Art

Traditionally, computer users often require access to files and/or documents on a networked computer system. These files may be maintained on a file server, and are typically accessed using user applications, such as email applications and word processing applications. Files may be maintained on an intranet, which is a network that restricts access to authorized users within a particular company or organization. Files on the intranet may be retrieved using a variety of methods.

One method commonly used for retrieving files from a file server is to use the organization of files on the file server to provide a user with sufficient information to find particular files. For example, information can be provided by organizing files in folders and/or subfolders, where the names of the folders and subfolders are used to indicate which files are located within the folders, or information can be provided by sorting files by date within a specific folder. Another commonly-used method is to deploy a search engine on the intranet. The search engine may index the contents and metadata of the files on the intranet and make them available to one or more users using a search bar. When a user enters a search query into the search engine, the search engine retrieves any matching documents and displays them to the user.

However, using a traditional search engine has disadvantages. For instance, a search engine may not be able to correctly assess the relevance of a document, and will therefore not be able to rank the documents in order of relevance when presenting them to the user. Also, a search engine may not be able to effectively assess a document if it does not contain textual information, which is necessary for most search engines to retrieve data. Further, a search engine is not discriminating in that it will return any and all hits. This can produce a large number of hits, many of which may be irrelevant, may include old documents or old versions of documents, and/or may include documents that are rarely or infrequently accessed. Also, the ways in which the resulting hits can be presented to the user are limited. The resulting hits can be organized by file name, data created, last date accessed, etc. This results in a user having to look through all the hits in order to find the desired document or documents.

Therefore, there is a need in the art to provide alternative document retrieval systems for use on intranets and other networks. In particular, there is a need in the art to provide systems and methods for automatically providing data-driven documents suggestion in a variety of situations.

Accordingly, it is desirable to provide methods and systems that overcome these and other deficiencies of the related art.

### SUMMARY

In accordance with the disclosed subject matter, systems and methods are provided for automatically providing data-driven document suggestions in a computer system.

The disclosed subject matter includes a method for providing at least one document suggestion from a computer system using at least one information source, the method comprising storing in the information source a plurality of associations, each of which includes a numeric coefficient that corresponds to at least one action of a user and at least one document; receiving a triggering action related to the at least one action of the user; comparing the numeric coefficients stored in the information source with a suggestion threshold based on the triggering action; and for each numeric coefficient that exceeds the suggestion threshold, identifying the corresponding at least one document as a suggested document.

The method further comprises tracking the one action of the user, updating the numeric coefficient that corresponds to the at least one action of the user and the at least one document, presenting a notification of the one or more suggested documents at a user device, storing the user's actions in a data store, and identifying the one or more suggested documents based on the user's actions retrieved from the data store. The numeric coefficient relates the corresponding one of the one or more documents with a likelihood that the document will subsequently be retrieved. The numeric coefficient for at least two users' actions may be combined. Notifications of the one or more suggested documents to the user may be based on contextual information about one of the user and the user's actions, and may be presented to the user as an alert message on a mobile device. The actions may include one or more of: opening the file; saving the file; modifying the file; accessing the file; searching for the file; performing a keyword search; receiving an email; receiving an email containing an attached file; reaching a time of day; and a null action.

The disclosed subject matter also includes a system for providing document suggestions in a communications network, the system comprising one or more interfaces configured to provide communication with a server via communication network; a processor, in communication with the one or more interfaces, and configured to run a module stored in memory that is configured to store in the information source a plurality of associations, each of which includes a numeric coefficient that corresponds to at least one action of a user and at least one document, receive a triggering action related to the at least one action of the user, compare the numeric coefficients stored in the information source with a suggestion threshold based on the triggering action, and for each numeric coefficient that exceeds the suggestion threshold, identify the corresponding at least one document as a suggested document, wherein the suggested documents are subsequently suggested to a user.

The system may further comprise a storage system for storing numeric coefficients assigned to files. One or more notification modules, for providing document suggestions to a user, application modules, configured to track a set of user actions specific to an application, may also be included.

The disclosed subject matter also includes a non-transitory computer-readable medium having executable instructions operable to cause a device to store in the information source a plurality of associations, each of which includes a numeric coefficient that corresponds to at least one action of a user and at least one document, receive a triggering action related to the at least one action of the user, compare the numeric coefficients stored in the information source with a suggestion threshold based on the triggering action, and for each numeric coefficient that exceeds the suggestion threshold, identify the corresponding at least one document as a suggested document, wherein the suggested documents are subsequently suggested to a user.

The executable instructions may further comprise instructions to track the one action of the user, and update the numeric coefficient that corresponds to the at least one action of the user and the at least one document. Numeric coefficients relate each file with a likelihood that the file will subsequently be retrieved. The executable instructions may further comprise instructions to combine the numeric coefficients for at least two user actions, and instructions to present notifications of the suggested documents to the user based on current contextual information about the user. The user actions include one or more of: opening a file; saving a file; modifying a file; accessing a file; searching for a file, performing a keyword search, receiving an email, and receiving an email containing an attached file.

There has thus been outlined, rather broadly, the features of the disclosed subject matter in order that the detailed description thereof that follows may be better understood, and in order that the present contribution to the art may be better appreciated. There are, of course, additional features of the disclosed subject matter that will be described hereinafter and which will form the subject matter of the claims appended hereto.

In this respect, before explaining at least one embodiment of the disclosed subject matter in detail, it is to be understood that the disclosed subject matter is not limited in its application to the details of construction and to the arrangements of the components set forth in the following description or illustrated in the drawings. The disclosed subject matter is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the disclosed subject matter. It is important, therefore, that the claims be regarded as including such equivalent constructions insofar as they do not depart from the spirit and scope of the disclosed subject matter.

These together with the other objects of the disclosed subject matter, along with the various features of novelty which characterize the disclosed subject matter, are pointed out with particularity in the claims annexed to and forming a part of this disclosure. For a better understanding of the disclosed subject matter, its operating advantages and the specific objects attained by its uses, reference should be had to the accompanying drawings and descriptive matter in which there are illustrated preferred embodiments of the disclosed subject matter.

### BRIEF DESCRIPTION OF THE DRAWINGS

Various objects, features, and advantages of the disclosed subject matter can be more fully appreciated with reference to the following detailed description of the disclosed subject matter when considered in connection with the following drawings, in which like reference numerals identify like elements.

FIG. 1 is a network connectivity diagram of a networked system in accordance with some embodiments of the invention.

FIG. 2 is a schematic diagram of user action tracking for a client device using a networked system in accordance with some embodiments of the invention.

FIG. 3 is a schematic diagram of a document suggestion alert on a computer operating system in accordance with some embodiments of the invention.

FIG. 4 is a schematic diagram of a document suggestion alert on an intranet web page in accordance with some embodiments of the invention.

FIG. 5 is a schematic diagram of search results on an intranet web page in accordance with some embodiments of the invention.

FIG. 6 is a flow diagram of identifying documents for suggestion in accordance with certain embodiments of the invention.

FIG. 7 is a flow diagram of identifying documents for suggestion using a notification module in accordance with certain embodiments of the invention.

FIG. 8 illustrates a block diagram of a client device in accordance with certain embodiments of the invention.

FIG. 9 illustrates a block diagram of a server device in accordance with certain embodiments of the invention.

### DETAILED DESCRIPTION

In the following description, numerous specific details are set forth regarding the systems and methods of the disclosed subject matter and the environment in which such systems and methods may operate, etc., in order to provide a thorough understanding of the disclosed subject matter. It will be apparent to one skilled in the art, however, that the disclosed subject matter may be practiced without such specific details, and that certain features, which are well known in the art, are not described in detail in order to avoid complication of the subject matter of the disclosed subject matter. In addition, it will be understood that the examples provided below are exemplary, and that it is contemplated that there are other systems and methods that are within the scope of the disclosed subject matter.

Users of present-day computer systems often need to retrieve files for various purposes. These files may be stored on local storage systems, or they may be stored on storage systems that are located on a network, such as an internal intranet network or the public Internet. The retrieval of these files may be for various purposes, such as editing documents, reviewing documents, or participating in meetings where documents are used. These documents may also be ones that are frequently used, or infrequently used, or ones that are tied to specific times of day or other usage patterns, or ones that are associated with a specific task or meeting.

One of the most common techniques today for finding documents is the use of search. Search involves using an application or intranet website configured to provide search and retrieval capabilities to find the document in question. Another common technique is to use a filing system to retrieve the document, based on knowledge about the location of the document on the system. For example, a file may relate to a particular client, project or product, and may logically be organized on the storage system in a folder or directory for that client, project or product. Many companies have elaborate systems for organizing information, using some combination of metadata, keywords and filing systems. These companies may also spend a significant amount of user time or administrator time to set up the appropriate storage or search systems.

Although these approaches have strengths and will undoubtedly continue to be available on computer systems, an approach is suggested herein where documents can be predictably retrieved and automatically suggested. There are many situations in which this would be useful, and an exemplary system is described below for providing such a document suggestion system.

To provide document suggestions, analysis is needed to determine which files are important. This analysis may be performed on user tracking data, where such data may be correlated with files. User tracking may include the tracking of user actions, such as the opening, modifying, saving, moving, renaming, and/or sending of files, the searching for a given set of terms and/or files, and the sending of emails. User actions may also include saving a file, clicking on a link, sending a calendar invitation, changing a calendar invitation, accepting a calendar invitation, performing a search, updating a database record, viewing metadata about a file or record, communicating with a user via an email, using specific key words in an email, or accessing an application. User actions may also include any inputs that are available to the system, such as information about the user's environment, including lighting, heating, ventilation and air conditioning (HVAC) control, use of or association with specific WiFi access points, use of remote access devices or tools, use of security badges to gain access to secured physical locations, use of electronic credentials to log into or out of a system, or other inputs. Any other suitable user actions or combination of user actions may be tracked.

User tracking may also include tracking of contextual information around each action. For example, when a file is opened, the system may track the time of day when it is opened, whether the file was opened in response to receiving an email, whether the opened file was subsequently edited, whether the opened file was subsequently sent and to whom, from whom the email was sent, and any other suitable contextual information or combination of contextual information. As another example, when a given set of search terms is used to search, the system may track which results are selected. This allows the system to determine that there is a correlation between the search terms and the results, or the file and the received email.

In order to track user data, the present disclosure describes a tracking system that is in communication with an application program. When the application program performs a user action, such as opening a file or sending an email, a tracking program may monitor and save this information. In some cases this may require modification of the application program. Examples of an application program for this purpose include a mail client such as Microsoft Outlook or Apple Mail or any webmail interface, a mail server such as Microsoft Exchange Server or any industry-standard Internet Mail Application Protocol (IMAP) or Post Office Protocol (POP) server, a document management system such as Interwoven iManage, a source code revision control and tracking system such as Perforce, Subversion or Git, a bug tracking system such as Bugzilla, a calendaring program such as Microsoft Outlook and/or Microsoft Exchange Server, a content management system (CMS) such as WordPress or Verity, a customer relationship management (CRM) system such as Siebel or Peoplesoft, a general database such as Oracle, MySQL or PostgreSQL, or any other suitable application program or combination of application programs.

User tracking may be performed at a server in some embodiments. In other embodiments, it may be performed at a local computing device, as part of the system used by the user. The application may be customized as necessary in order to capture the most relevant contextual information for document suggestion. For example, a Microsoft Exchange server may be customized to track user actions such as receiving, sending, opening and deleting emails. This enables the present system to correlate documents and/or emails with these actions, and also allows the present system to provide suggestions when these actions are performed. In some embodiments, a centralized user action tracking server may be used, and the tracking server may be a software module executing on a physical computing device. The tracking server may operate on the same physical server or computing device as is used by other resource servers within the organization, such as a file server, storage area network (SAN) server, Microsoft Exchange server, Internet Mail Application Protocol (IMAP) server or other email server, World Wide Web server, or other shared intranet server. This offers the advantage of increased performance when communicating between the user tracking server and the intranet server. In other embodiments, the user tracking server may be located on another server, which enables use of the invention with Internet servers and other servers that are not under the organization's control.

In certain embodiments, user tracking may be performed at a client device or user device. This may be the case on a mobile device, where it may be difficult to guarantee connectivity to a remote server for immediate communication of tracked actions, or where monitoring actions performed at applications on the user device is not possible from a remote server. In certain embodiments, user tracking may be performed both at a client device and a server.

The present system allows for the establishment of suggestion rules based on tracked user actions. Specific user actions or contextual information around a user's interaction with an application may be used as triggers. When the specified actions or contextual information is detected by a user action tracking system, the system may act to suggest documents. It is important that a variety of applications be supportable by the present system, in order to provide helpful and useful suggestions to the user based on the user's own activity across many applications. For this purpose, the present system is built in a modular fashion, such that a large number of user actions may be supported by a single tracking and suggestion module. The module keeps track of individual documents or files and their correlations with user actions.

Many user actions may be tracked, including opening files, saving files, emailing files to others, associating files with calendar entries, searching for keywords, opening files after searching for keywords, organizing files into folders, and other actions. The actions need not be related to files; for example, associating with a WiFi hotspot, sending GPS location data to a server, sending, receiving, opening, or forwarding email, or any other action could be tracked as well. The additional tracking information allows the system to provide better contextual suggestions.

In the present system, correlations are associated with each document using a numeric value that reflects the correlation. This numeric value may be a value between 0 and 1, in some embodiments. Each document is given one or more numeric scores, which are modified when user actions are correlated with that document. For example, if a document is opened, the stored score for that document is modified by a certain amount. The amount can be set based on how likely the particular user action is to lead to the user re-opening the document. An alpha decay function automatically reduces the numeric score over time, so that recently-used documents are more likely to be suggested than less-accessed documents.

The weighting process involves assigning a coefficient to each action, based on an a priori set of rules, or based on a machine learning process that adjusts coefficients automatically. These coefficients are associated with individual files. More than one coefficient may be associated with a file, based on particular context. More than one coefficient may be associated over time as well. When more than one coefficient is associated with a single file, the new and old coefficients may be combined, according to predetermined rules. Coefficients in the system may be subject to an alpha decay rule, such that more recent coefficients are weighted heavily and old coefficients gradually decay. The result of the alpha decay rule is to provide suggestions more frequently for documents that have been recently accessed or acted upon. In certain embodiments, multiple coefficients are associated with each file, so that each action performed by a user that is tracked by the system is correlated to one or more files by storing or updating a coefficient associated with the one or more files and associated with the action. This provides a multi-dimensional weighting for each file based on different aspects of user activity and different users' activity. In other embodiments, a single set of coefficients is kept for each user and/or file pairing. These coefficients are also called weights or weight coefficients.

Various algorithms, heuristics and rules may be used for determining the values of coefficients for file-action association and for determining the threshold and alpha decay values. In some embodiments, the determination of which files to suggest may be performed probabilistically.

In certain embodiments of the invention, an application module is used. The application module facilitates selection of the coefficient for a given file-action association that may be specific to the application, in order to provide suggestions that are useful to the user. For example, if a software developer is using his computer, and has clicked on a bug report in a bug reporting system, documents that are relevant to that bug report may be retrieved and presented to the software developer via a notification system. The action “click on bug report” may be associated with each of the documents associated with the selected bug report and a high coefficient may be assigned, so that when the user clicks on the bug report, the documents are returned. The rules and coefficients may thus be highly specialized. The desired specificity may be described in object code, a scripting language, natural language, by the user using a software rule-building tool, or by other means, in certain embodiments.

Another example is as follows. If a user is using her computer, and she has a meeting at 10 A.M. for which a coworker has emailed her several documents, the documents may be automatically suggested for her at 9:50 A.M., so that she can open and print the documents prior to her meeting. This example is made possible by a specific rule that assigns a high coefficient for the association of the received documents with the action “receive as attachment from coworker,” and also assigns a high coefficient for the association of documents received from the coworker with the action “request reminder ten minutes before meeting with coworker.” When both of these actions are performed by the user, as in the provided example, the associated documents are retrieved, and if the combined coefficients for each file are high enough to exceed a threshold, the documents are suggested.

A plurality of application modules may be used in conjunction with a user action tracking server as follows. Rules that are specific to a particular application may be specified in computer code that executes in an application module, potentially using an application programming interface (API) specific to the application, such that the application module is thus a module that enables user action tracking within one or more specific applications. In some embodiments, a user action tracking server may monitor and track user actions without the use of application modules. For a user environment where actions relating to in multiple applications or multiple environments, an application module for each application or environment may observe user actions performed within the specific application. Once user actions are observed, they may be transmitted to a server that is a user action tracking server, via a network, inter-process communication (IPC), or other means. The user action tracking server may receive user actions from multiple application modules and may use the received user actions to perform tracking, triggering and other functions as described herein.

In some embodiments, the system may track different content elements. For example, emails may be tracked as well as files or documents. Thus, emails may be provided as suggested content elements regardless of whether the emails are stored in a database or a file system. In other embodiments, individual sales contacts, individual content objects in a CMS, individual bugs in a bug tracking system, or arbitrary data objects in a database may be tracked in addition to, or in lieu of, tracking files. One or more of these tracked objects may be present in the same system or embodiment. Document suggestions may be provided for each object or for a configurable subset of these objects.

In some embodiments, user tracking may be provided by one system to multiple users in a corporation or organization. When used in an organization, user actions performed by others may also be used to provide correlation data. For example, in an organization where all coworkers' access to an expense report spikes on the 26th of the month, each coworker can be suggested the document at that time on the basis of other coworkers' actions. The system may track connections between users using a social network to accommodate user action tracking for only relevant users.

To provide document suggestions, a notification scheme can be used. Notifications are provided automatically to the user, or may also be presented at appropriate times after a user action has taken place. For example, a user may turn on his computer and be notified of a document suggestion as soon as the computer is turned on. The user may be notified of a file based on a time of day or a calendar notification. The user may be notified when he browses the web to a certain website, or opens a particular project folder in the document management system. In other words, the user may be notified at times which are contextually determined to be the time when the documents are helpful.

Notifications may take various forms. In the previous example, if the bug report is on an intranet page, the notification may be inserted into the web page. If a notification via email, phone call, or text message is desired, such notifications may also be used. If a notification via another notification method is desired, such as Apple iOS push notification, instant message, or a pop-up notification on a desktop, mobile, tablet computer, or cellular telephone, such notifications may also be used. In each case, the notification includes one or more files that are deemed to be relevant by the system. The user may also be presented with an opportunity to act on the notification by, e.g., opening the file or files suggested by the document suggestion system.

In some embodiments, searching may also be enhanced by the described document suggestion system. For example, when a user performs a search, the search engine may return regular search results and may also include alternative results based on stored correlations in the document suggestion system. As another example, the search engine may simply return the results based on stored correlations in the document suggestion system.

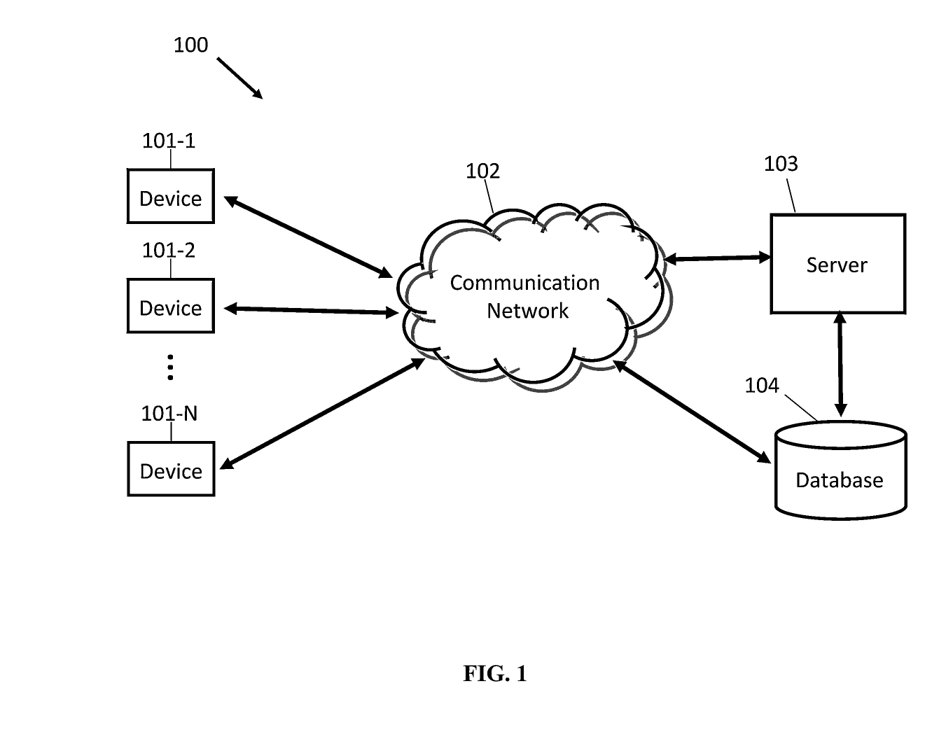

FIG. 1 is a network conductivity diagram of a networked system in accordance with some embodiments of the invention. Network system 100 is a client/server system, in which at least one client 101 (e.g., devices 101-1, 101-1, . . . 101-n) and server 103 communicate via communication network 102. Device 101 is a mobile device or user-operated device associated with a user. Device 101 can be any suitable device, including desktop computers, mobile computers, tablet computers, and cellular phones. Users use device 101 to communicate with applications on server 103. In the case of mobile devices, such as smartphones (e.g., Apple iPhones or Android-based smartphones), the devices may run agent software that performs user action tracking and communicates with the server 103. Server 103 saves data to, and retrieves data from, database 104. In some embodiments, database 104 is accessed by server 103. In other embodiments, database 104 is accessed by other devices on the communication network 102, including devices 101. In some embodiments, device 101 may run only standard application programs and standard operating system software, such as Mozilla Firefox running on a version of the Microsoft Windows operating system. In other embodiments, device 101 may run specialized or customized application programs that communicate with user action tracking software on server 103.

Users perform actions on devices 101, which are then communicated via communication network 102 to server 103. On server 103, a user action tracking server (not shown) sits alongside an application server (not shown) in some embodiments of the invention. In other embodiments of the invention, the user action tracking server may reside on device 101 or on database 104. According to some embodiments of the invention, user action tracking server (not shown) communicates with a document suggestion module (not shown) that returns documents suggestions to the user of device 101. The document suggestion module (not shown) may reside at server 103, or elsewhere on the network.

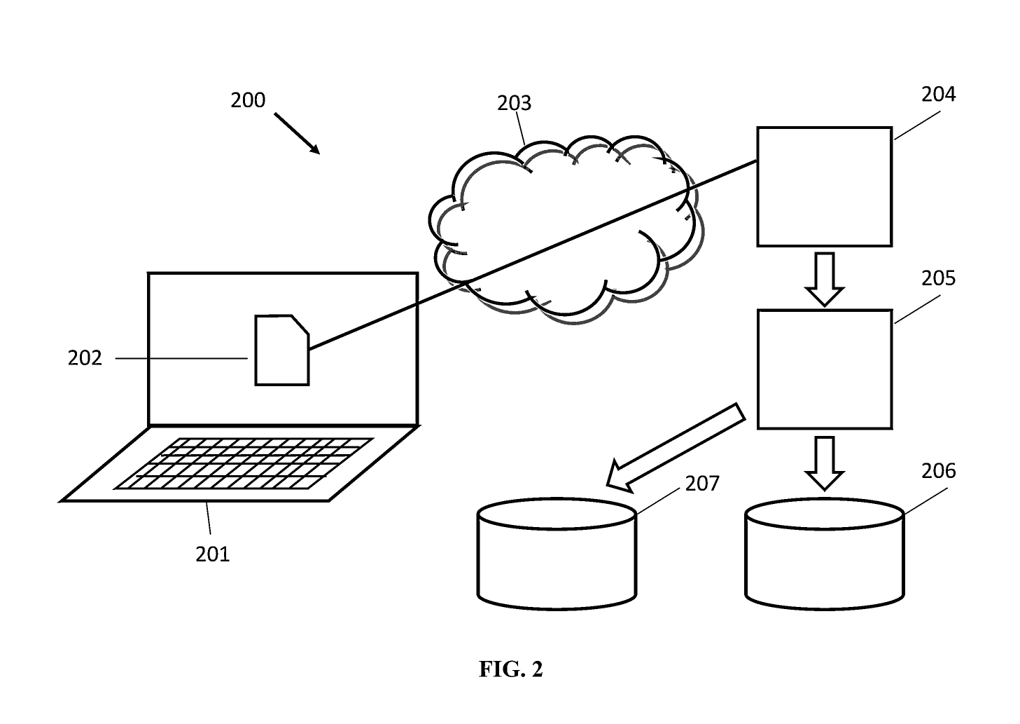

FIG. 2 is a schematic diagram of user action tracking for a client device using a network system, in accordance with some embodiments of the invention. A user uses a user device 201 to access file 202. The user then performs a user action on the file, such as saving the file, opening the file, modifying the file, or another action. This action is performed via communication network 203. For example, the user could save the file to storage pool 206. According to certain embodiments of the invention, the request to save the file would first pass through an application server 204, e.g., a file server application or a mail server application. According to certain embodiments of the invention, user action tracking server 205, residing on the same server as the application server, would be notified of the user action. User action tracking server 205 may then record the user action, update metadata for the file to reflect a user action in storage pool 206, and allow the file to be stored in storage pool 207. Storage pool 206 is used by user action tracking server 205. Storage pool 207 is used by the application server 204 as a file store, email store, or other application data store. The metadata that is updated by the user action tracking service is described hereinbelow.

In some embodiments of the invention, the user action tracking server may be located on user device 201 or on another device in the network. In some embodiments of the invention, the storage system used for storing metadata associated with each file may be located on local device 201 or elsewhere in the network. In some embodiments of the invention, the user action tracking server 205 may intercept messages before they reach the application server 204. In some embodiments of the invention, there may be more than one application server and/or more than one user action tracking server; in the case when there is more than one application server, user actions may be tracked by one or more user action tracking servers. Each user action tracking server may be co-located with the document suggestion module (not shown), or may be located on another server. The user action tracking servers may also be configured to send out notifications periodically to the document suggestion server, or on an as-needed basis, e.g., by “pushing” relevant user actions to the document suggestion server.

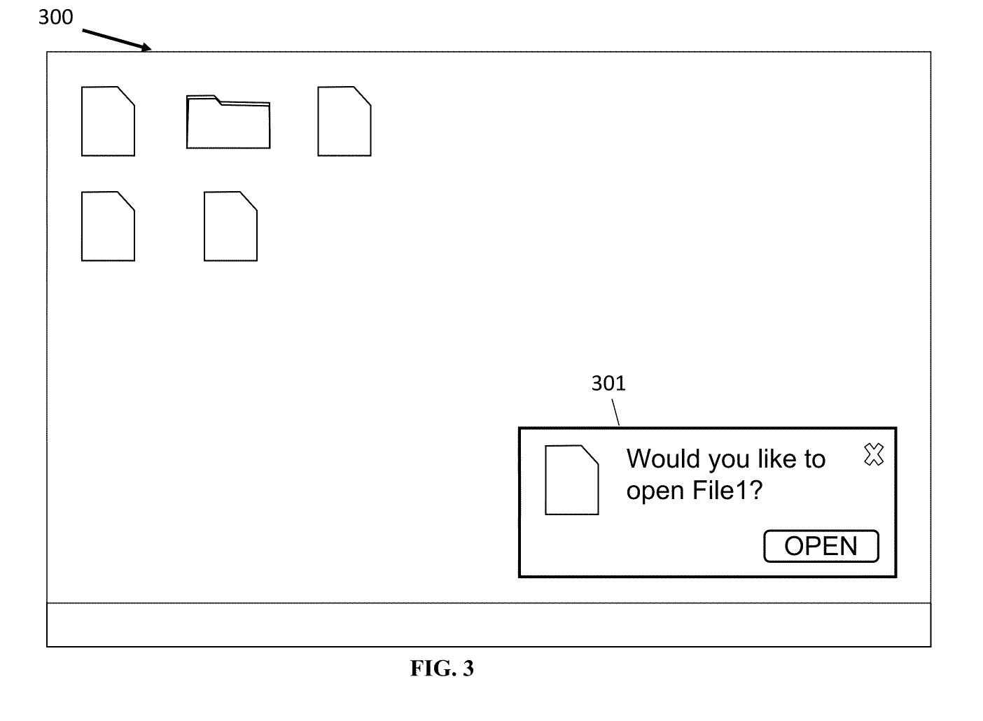

FIG. 3 is a schematic diagram of a document suggestion alert on a computer operating system in accordance with some embodiments of the invention. Schematic view 300 is a representation of a screen of a user device on a computer operating system. Document suggestion alert 301 appears on the screen of the user device. This alert 301 may occur when the user is performing an action that would be facilitated by document suggestions. The alert may be based on a time of day, on a contextual cue such as the application being in use, information about the user's current activity, such as derived from currently open documents and or applications, or other suitable factors. In certain embodiments of the invention, it is not necessary for the user to enter explicit search terms, or otherwise indicate to the system that he or she wishes to open a document. In certain embodiments of the invention, user actions may be monitored to determine when it is appropriate to offer document suggestions. The suggestions may be offered immediately when turning on a computer. The alert may be a Google alert, a non-modal alert, and may be offered alone or in combination with other alerts. One file, or a plurality of files, may be suggested to the user. The alert may be an instant message, an email, a pop-up notification, a text message or SMS, or another suitable type of notification. The alert may include any suitable content, including text, images, and/or a link to one or more files. The user is presented with the opportunity to act on the notification, including opening the suggested file or files.

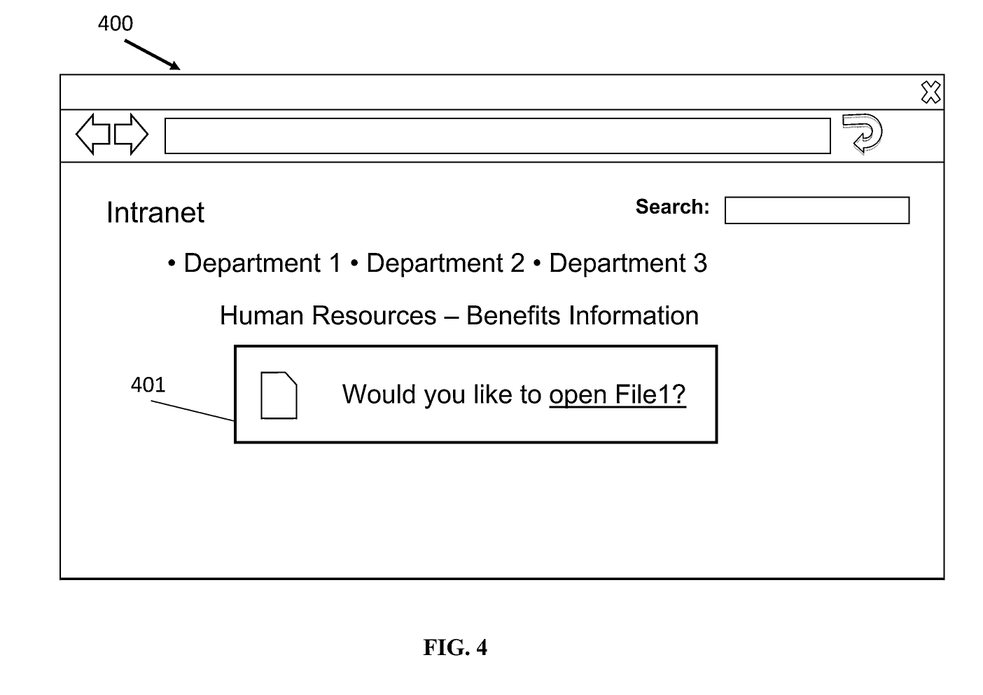

FIG. 4 is a schematic diagram of a document suggestion alert on an intranet webpage, in accordance with some embodiments of the invention. The representative web browser 400 is shown, together with document suggestion alert 401. Additional content from a user's intranet is shown as well. The document that is suggested is contextualized according to the particular intranet page and according to other information about the user's current activity. This other information may include information aggregated from other users within the user's organization. An example would be for a user to be presented with a suggestion to open a particular file that other users in the organization found useful. Searching is also possible on an intranet website, and indeed, search context, including search terms, may be used to contextualize the document suggestion. The document suggestion system may include one or more rules that enable the system to understand the context of the user's actions, including context based on actions by other users. As in the previous figure, the user is presented with an opportunity to interact with and open a suggested file.

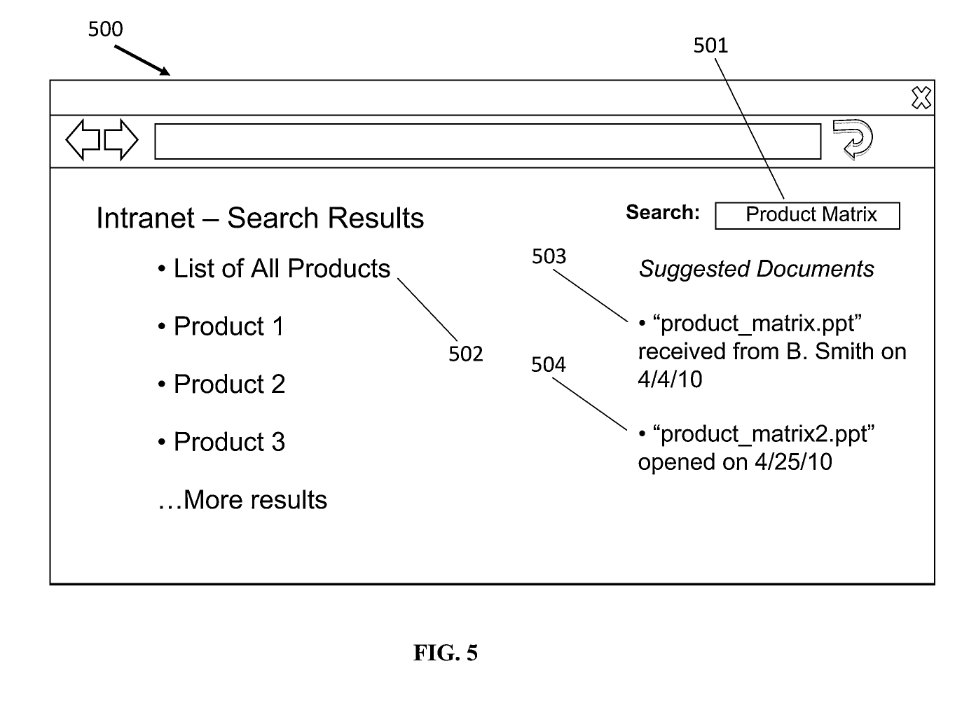

FIG. 5 is a schematic diagram of search results on an intranet web page supplemented in accordance with some embodiments of the invention. The representative web browser 500 is shown. Searching is also possible on an intranet website, and indeed, search context, including search terms, may be used to contextualize the document suggestion. The document suggestion system may include one or more rules that enable the system to understand the context of the user's actions, including context based on actions by other users. As in the previous figure, the user is presented with an opportunity to interact with and open one or more suggested files. In the figure, search terms 501 have been previously entered by the user, and the intranet has retrieved search results 502 using a search engine as is known in the art. As well, in accordance with the invention, the search and the search terms have been tracked by a user action tracking server (not shown), which has provided supplemental search results in the form of suggested documents 503 and 504. The suggested documents match the search terms, and also are highly correlated to the user and to activities performed by the user. The user action information used to match the documents to the query may be shown to the user in some embodiments. For example, the first suggested document 503 indicates that it was received in an email from B. Smith on Apr. 4, 2010. The second suggested document 504 indicates that the searching user previously opened the document.

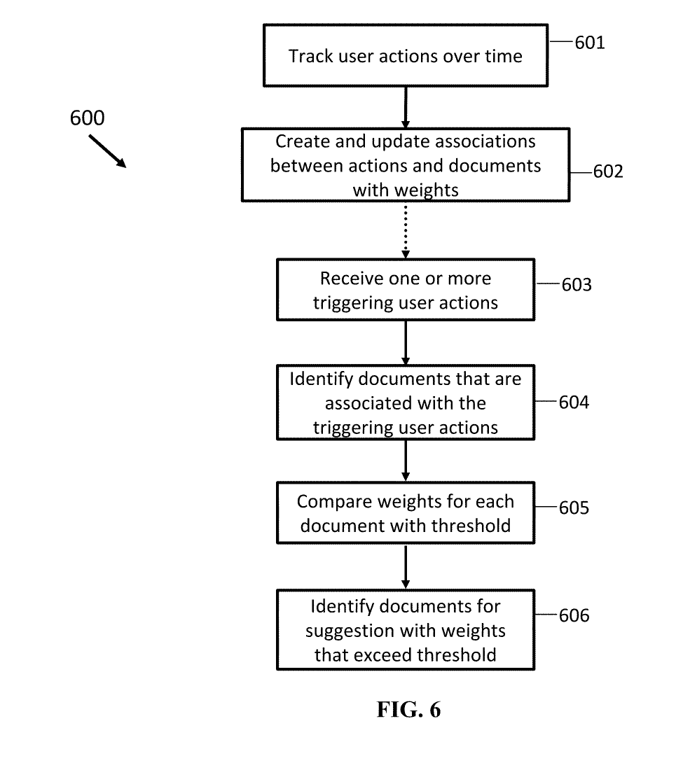

FIG. 6 is a flow diagram of identifying documents for suggestion in accordance with certain embodiments of the invention. At step 601, user actions are tracked over time. User actions may be tracked for a plurality of users. Tracking may be initiated as a result of a timer, receipt of user action, or based on periodic re-analysis of user actions and file coefficients, in certain embodiments of the invention. At step 602, tracked user actions are associated with documents, and the action and document are also associated with a numeric coefficient according to rules as described above. Steps 601 and 602 may occur in real time, at a time delay, on the same server as steps 603 and following, or on a different server. Steps 601 and 602 may be repeated for many actions and for many users. If a numeric coefficient already exists, step 602 may update it by resetting an alpha decay timer or by adding a value to the previously-stored value.

At step 603, the system begins processing document suggestion information based on a notification of a user action relating to a file received from one or more users. This user action may be the same user action initially tracked at step 601; in other words, the system may immediately attempt to suggest documents to a user as soon as one action is received. At step 604, all documents that are associated with the action are identified using the user action tracking data store. Each document associated with the action has a numeric coefficient that indicates whether it should be offered as a suggestion. At step 605, the coefficient for each document is compared with a threshold value. At step 606, if the coefficient for a document exceeds the threshold, the document is identified as a document that may be suggested to the user.

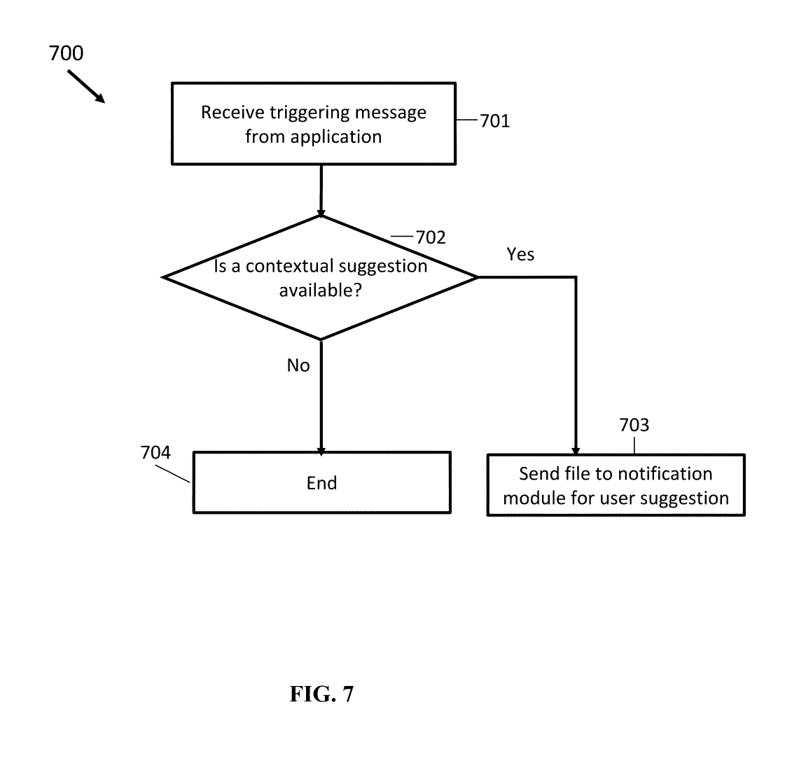

FIG. 7 is a flow diagram of identifying documents for suggestion using a notification module, in accordance with certain embodiments of the invention. At step 701, a document suggestion module is in communication with, and receives a triggering action from an application. This cues the document suggestion module to provide any available document suggestions. The triggering action may be a scheduled timer or interrupt timer, which is a special case of a user action. The triggering action may also be a message based on a user action, such as accessing a particular folder or application, or such as another user taking action on a file by, e.g., emailing a file to the current user. The triggering action may be related to previous actions performed by the same user or other users by a rule, and may be an action in the same application or a related application.

At step 702, the document suggestion module determines whether a suggestion is available. Certain suggestions may takes into account the user's current application and recent user actions, or other contextual information such as upcoming calendar appointments or physical location. For example, a user may have a meeting at 10 AM, and the user may have received documents pertaining to that meeting via email. At 9:50 AM, the user should receive a suggestion to open documents contained in the email. The system enables the suggestion to be sent to the user by triggering the document suggestion module at 9:50 AM based on contextual information from the user's calendar. If a suggestion for a document to be opened or accessed is available, the file or files to be suggested is determined and sent to the notification module for suggestion to the user at step 703.

As another example, if a user accesses an organization's intranet, and reaches a webpage pertaining to company-wide policies, the system may take into account documents that other users within the organization have retrieved from the company-wide policies section of the intranet, and suggest those documents to the current user. The invention is not limited to an intranet, but may also extend to documents/files retrieved from the Internet.

In the absence of contextual cues, the system may provide suggestions for most-recently used documents for the current user, most-recently used documents for all users, or relevant results for a search, if search terms were entered as part of the user action. This is equivalent to a system that is configured to correlate or associate document suggestions for a null action for a given user. If no suggestions are available, processing is terminated at step 704.

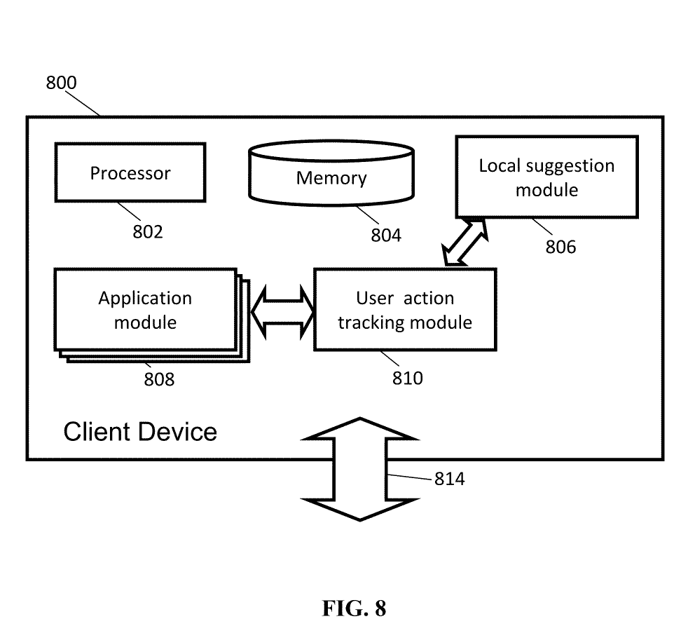

FIG. 8 shows client device 800 in accordance with certain embodiments of the disclosed subject matter. Client device 800 includes processor 802, memory 804, local suggestion module 806, application module 808, user action tracking module 810, and interface 814. In other embodiments of the invention, client device 800 can include additional modules, fewer modules, or any other suitable combination of modules that perform any suitable operation or combination of operations. The memory 804 can be a non-transitory computer readable medium, flash memory, a magnetic disk drive, an optical drive, a programmable read-only memory (PROM), a read-only memory (ROM), or any other memory or combination of memories. The software runs on a processor 802 capable of executing computer instructions or computer code. The processor 802 might also be implemented in hardware using an application specific integrated circuit (ASIC), programmable logic array (PLA), field programmable gate array (FPGA), or any other integrated circuit.

An interface 814 provides an input and/or output mechanism to communicate over a network. The interface 814 enables communication with servers, as well as other network nodes in the communication network. The interface 814 is implemented in hardware to send and receive signals in a variety of mediums, such as optical, copper, and wireless, and in a number of different protocols some of which may be non-transient.

The client device 800 can include user equipment of a cellular network. The user equipment communicates with one or more radio access networks and with wired communication networks. The user equipment can be a cellular phone having phonetic communication capabilities. The user equipment can also be a smart phone providing services such as word processing, web browsing, gaming, e-book capabilities, an operating system, and a full keyboard. The user equipment can also be a tablet computer providing network access and most of the services provided by a smart phone. The user equipment operates using an operating system such as Symbian OS, iPhone OS, RIM's Blackberry, Windows Mobile, Linux, HP WebOS, and Android. The screen may be a touch screen that is used to input data to the mobile device, in which case the screen can be used instead of the full keyboard. The user equipment can also keep global positioning coordinates, profile information, or other location information.

The client device 800 also includes any platforms capable of computations and communication. Non-limiting examples can include televisions (TVs), video projectors, set-top boxes or set-top units, digital video recorders (DVR), computers, netbooks, laptops, and any other audio/visual equipment with computation capabilities. The client device 800 is configured with one or more processors 802 that process instructions and run software that may be stored in memory. The processor 802 also communicates with the memory and interfaces to communicate with other devices. The processor 802 can be any applicable processor such as a system-on-a-chip that combines a CPU, an application processor, and flash memory. The client device 800 can also provide a variety of user interfaces such as a keyboard, a touch screen, a trackball, a touch pad, and/or a mouse. The client device 800 may also include speakers and a display device in some embodiments.

Client device 800 is operable according to some embodiments of the invention as follows. A user using client device 800 uses applications, which may be stored in the memory and/or be run on the processor. The applications may also be in communication with one or more application modules 808. Application module(s) 808, as discussed in detail above in paragraph [0045], provides access to one or more applications in order to allow tracking of user actions performed within the applications. User action tracking data may be shared with user action tracking module 810, which tracks user actions and sets up associations between users, actions, and documents (or other objects). User action tracking module 810 may be in communication with other client devices or servers using interface 814, in order to provide synchronization across devices, to provide multi-user tracking capability, or to off-load one or more functions to a user action tracking server. In some embodiments, a local suggestion module 806 may be present and may use the user actions and associations stored by the user action tracking module to suggest documents. More commonly, this functionality may be provided by a server device, as described below.

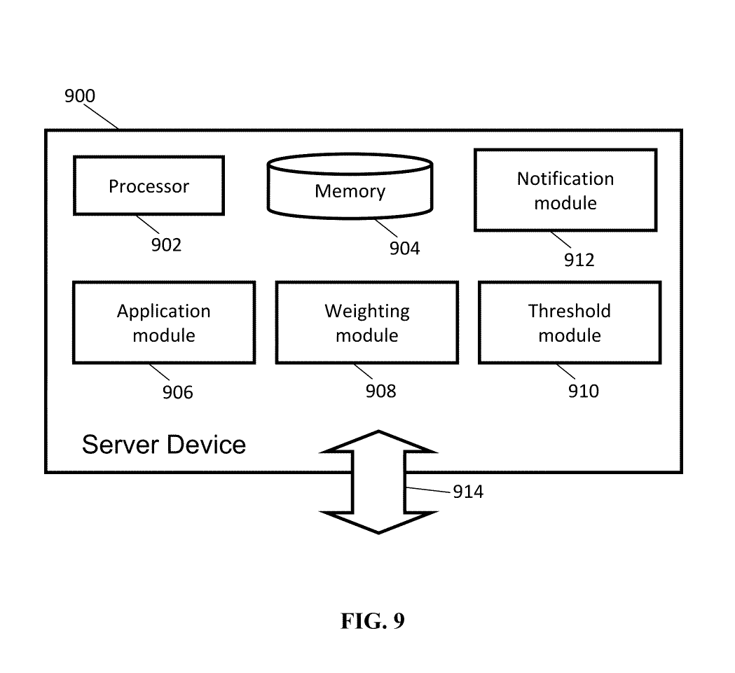

FIG. 9 is a block diagram of a server device in accordance with certain embodiments of the invention. Server device 900 includes processor 902, memory 904, application module 906, weighting module 908, threshold module 910, and notification module 912. Processor 902 performs processing for one or more modules as disclosed in this specification. Memory 904 provides temporary storage of data as required by the processor 902. The memory 904 can be a non-transitory computer readable medium, flash memory, a magnetic disk drive, an optical drive, a programmable read-only memory (PROM), a read-only memory (ROM), or any other memory or combination of memories. The software runs on a processor 902 capable of executing computer instructions or computer code. The processor 902 might also be implemented in hardware using an application specific integrated circuit (ASIC), programmable logic array (PLA), field programmable gate array (FPGA), or any other integrated circuit.

Application module 906 is in communication with an application or application server, as disclosed elsewhere in the specification, and enables user action tracking. Application module 906 may be written to be interoperable with the application or application server (not shown). Alternatively, application module 906 may interact with the application using an application programming interface (API). Weighting module 908 applies coefficients to create correlations between user actions and files, as described herein. Weighting module 908 may use an a priori table of coefficients, or may use machine learning or dynamic techniques to determine the coefficients. For example, the weighting module 908 may be configured to assign a higher coefficient to a user action for a given file when the user action is modifying and saving the file, as opposed to merely opening the file. Any system of assigning coefficients or learning appropriate coefficients may be used. The weighting module 908 may also be configured to get higher or lower priority or weight to actions performed by other users. Threshold module 910 may perform comparisons of file coefficients associated with files with a global or contextual threshold, as described in FIG. 5 and accompanying text. Notification module 912 may determine when and how to present document suggestions to the user, and may integrate with user devices and client operating systems to enable notification. Interface 914 may allow computer system 900 communicate with other systems, such as other devices on one or more networks, server devices on the same or different networks, or user devices either directly or via intermediate networks. The interface 914 may be implemented in hardware to send and receive signals in a variety of mediums, such as optical, copper, and wireless, and in a number of different protocols some of which may be non-transient.

In the case that more than one computer system providing document suggestion services is available on one or more networks, the devices may communicate with each other to share user actions and coefficients, enhance performance of the other suggestion server, and perform additional features in some embodiments of the invention.

The server 900 can operate using an operating system (OS) software. In some embodiments, the OS software is based on a Linux software kernel and runs specific applications in the server such as monitoring tasks and providing protocol stacks. The OS software allows server resources to be allocated separately for control and data paths. For example, certain packet accelerator cards and packet services cards are dedicated to performing routing or security control functions, while other packet accelerator cards/packet services cards are dedicated to processing user session traffic. As network requirements change, hardware resources can be dynamically deployed to meet the requirements in some embodiments.

The server's software can be divided into a series of tasks that perform specific functions. These tasks communicate with each other as needed to share control and data information throughout the server 900. A task can be a software process that performs a specific function related to system control or session processing. Three types of tasks operate within the server 900 in some embodiments: critical tasks, controller tasks, and manager tasks. The critical tasks control functions that relate to the server's ability to process calls such as server initialization, error detection, and recovery tasks. The controller tasks can mask the distributed nature of the software from the user and perform tasks such as monitoring the state of subordinate manager(s), providing for intra-manager communication within the same subsystem, and enabling inter-subsystem communication by communicating with controller(s) belonging to other subsystems. The manager tasks can control system resources and maintain logical mappings between system resources.

Individual tasks that run on processors in the application cards can be divided into subsystems. A subsystem is a software element that either performs a specific task or is a culmination of multiple other tasks. A single subsystem includes critical tasks, controller tasks, and manager tasks. Some of the subsystems that run on the server 900 include a system initiation task subsystem, a high availability task subsystem, a shared configuration task subsystem, and a resource management subsystem.

The system initiation task subsystem is responsible for starting a set of initial tasks at system startup and providing individual tasks as needed. The high availability task subsystem works in conjunction with the recovery control task subsystem to maintain the operational state of the server 900 by monitoring the various software and hardware components of the server 900. Recovery control task subsystem is responsible for executing a recovery action for failures that occur in the server 900 and receives recovery actions from the high availability task subsystem. Processing tasks are distributed into multiple instances running in parallel so if an unrecoverable software fault occurs, the entire processing capabilities for that task are not lost. User session processes can be sub-grouped into collections of sessions so that if a problem is encountered in one sub-group users in another sub-group will not be affected by that problem.

Shared configuration task subsystem can provide the server 900 with an ability to set, retrieve, and receive notification of server configuration parameter changes and is responsible for storing configuration data for the applications running within the server 900. A resource management subsystem is responsible for assigning resources (e.g., processor and memory capabilities) to tasks and for monitoring the task's use of the resources.

In some embodiments, the server 900 can reside in a data center and form a node in a cloud computing infrastructure. The server 900 can also provide services on demand. A module hosting a client is capable of migrating from one server to another server seamlessly, without causing program faults or system breakdown. The server 104/304 on the cloud can be managed using a management system.

It is to be understood that the disclosed subject matter is not limited in its application to the details of construction and to the arrangements of the components set forth in the following description or illustrated in the drawings. The disclosed subject matter is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods, and systems for carrying out the several purposes of the disclosed subject matter. It is important, therefore, that the claims be regarded as including such equivalent constructions insofar as they do not depart from the spirit and scope of the disclosed subject matter.

Although the disclosed subject matter has been described and illustrated in the foregoing exemplary embodiments, it is understood that the present disclosure has been made only by way of example, and that numerous changes in the details of implementation of the disclosed subject matter may be made without departing from the spirit and scope of the disclosed subject matter, which is limited only by the claims which follow.

What is claimed is:

1. A method for providing at least one document suggestion from a computer system using at least one information source, the method comprising:
storing in the information source a plurality of associations, each of which includes a numeric coefficient that corresponds to at least one action of a user and at least one document.
receiving a triggering action related to the at least one action of the user;
comparing the numeric coefficients stored in the information source with a suggestion threshold based on the triggering action; and
for each numeric coefficient that exceeds the suggestion threshold, identifying the corresponding at least one document as a suggested document.

2. The method of claim 1, further comprising:
tracking the one action of the user; and
updating the numeric coefficient that corresponds to the at least one action of the user and the at least one document.

3. The method of claim 1, further comprising presenting a notification of each suggested document at a user device.

4. The method of claim 1, wherein the numeric coefficients relate the corresponding at least one document with a likelihood that the document will subsequently be retrieved.

5. The method of claim 4, further comprising combining the numeric coefficients for at least two users' actions.

6. The method of claim 3, further comprising presenting the notifications of each suggested document to the user based on contextual information about one of the user and the user's actions.

7. The method of claim 3, further comprising presenting the notifications to the user as an alert message on a mobile device.

8. The method of claim 1, wherein the actions include one or more of: opening the file; saving the file; modifying the file; accessing the file; searching for the file;
performing a keyword search; receiving an email; receiving an email containing an attached file; reaching a time of day; and a null action.

9. A system for providing document suggestions in a communications network, the system comprising:
one or more interfaces configured to provide communication with a server via communication network; and
a processor, in communication with the one or more interfaces, and configured to run a module stored in memory that is configured to:
store in the information source a plurality of associations, each of which includes a numeric coefficient that corresponds to at least one action of a user and at least one document;
receive a triggering action related to the at least one action of the user;
compare the numeric coefficients stored in the information source with a suggestion threshold based on the triggering action; and
for each numeric coefficient that exceeds the suggestion threshold, identify the corresponding at least one document as a suggested document.

10. The system of claim 9, further comprising:
an application module for tracking user activity;
a weighting module for updating the numeric coefficient that corresponds to the at least one action of the user and the at least one document; and
a threshold module for comparing the numeric coefficient with the suggestion threshold and for determining whether to suggest the document to the user based on contextual user activity.

11. The system of claim 10, further comprising a notification module for providing document suggestions to a user.

12. The system of claim 9, wherein the suggested documents are subsequently suggested to a user.

13. The system of claim 9, further comprising a storage system for storing numeric coefficients associated with documents and actions.

14. The system of claim 9, further comprising one or more application modules configured to track a set of user actions that is specific to an application.

15. A non-transitory computer-readable medium having executable instructions operable to cause a device to:
store in the information source a plurality of associations, each of which includes a numeric coefficient that corresponds to at least one action of a user and at least one document;
receive a triggering action related to the at least one action of the user;
compare the numeric coefficients stored in the information source with a suggestion threshold based on the triggering action; and
for each numeric coefficient that exceeds the suggestion threshold, identify the corresponding at least one document as a suggested document.

16. The medium of claim 15, the executable instructions further comprising instructions to track the one action of the user, and update the numeric coefficient that corresponds to the at least one action of the user and the at least one document.

17. The medium of claim 15, wherein the numeric coefficients relate each file with a likelihood that the file will subsequently be retrieved.

18. The medium of claim 15, the executable instructions further comprising instructions to combine the numeric coefficients for at least two user actions.

19. The medium of claim 15, the executable instructions further comprising instructions to present notifications of the suggested documents to the user based on current contextual information about the user.

20. The medium of claim 15, wherein the user actions include one or more of:
opening a file; saving a file; modifying a file; accessing a file; searching for a file, performing a keyword search, receiving an email, and receiving an email containing an attached file.
